(19) United States
(12) Patent Application Publication
(10) Pub. No.: US 2004/0243438 A1
(43) Pub. Date: Dec. 2, 2004

(54) Method and system for cost analysis and benchmarking in the healthcare industry

(76) Inventor: Ilan Mintz, Rishon Le'Zion (IL)

Correspondence Address: HOGAN & HARTSON LLP, IP GROUP, COLUMBIA SQUARE, 555 THIRTEENTH STREET, N.W., WASHINGTON, DC, 20004, US

(21) Appl. No.: 10/481,768

(22) PCT Filed: Jun. 6, 2001
(86) PCT No.: PCT/IL01/00532

(51) Int. Cl. G06F 17/60; G06G 7/00

(52) U.S. Cl. 705/2; 705/400

(57) ABSTRACT

The present invention is an accurate cost analysis system (100) and method for medical products and services, which has the ability to determine actual costs and profitability for all levels within a healthcare organization and which, unlike existing financial systems, employs terms and data familiar to healthcare providers. The system collects data from existing information systems (101) in a healthcare organization, and process the data into actionable information. The system utilizes real data collected from the production floor in order to enable decision-makers to analyze the true costs of procedures and services provided to their clients, and to develop business strategies to improve profit margins.

### BACKGROUND OF THE INVENTION

1. Field of the Invention

The present invention relates to cost analysis in the healthcare industry. More specifically, the present invention relates to method and software application system, preferably implemented within a framework of a web-hosted configuration, for providing activity-based cost-analysis and cost-control services for all levels of the healthcare industry. In particular the present invention enables individual patient care units within an organization in becoming independent profit centers.

2. Discussion of the Related Art

The healthcare industry is unique in its complexity and in the volume of diverse support services which are required in order to deliver patient care. Recent departure from traditional approaches to healthcare delivery has been spurred by the need to reduce costs while maintaining excellent quality of care. A healthcare institution's survival depends nowadays on having a firm grasp of the realities of expenses and income. However, because of the complex nature of medical care service data, the vast majority of institutions are faced with poor and outdated information regarding the real cost of the healthcare services they provide. Many clinicians and healthcare administrators are not able to efficiently utilize the available data in order to clearly identify real costs. In a typical medical center 60 percent of expenditures required to support an episode of care may not be represented by the cost pools identified with the medical and health care team most closely associated with the patient. Current approaches to healthcare financial management suffer from a number of drawbacks. Existing healthcare financial management systems cannot provide detailed cost information because they focus on billing and not on expenses. The amount of payment is made from a calculation using different billing systems, which use average fixed rates, regardless of the actual cost to the health provider. In addition, in most cases, financial reports are not delivered in real time and therefore are often inaccurate. The lack of reliable and updated information makes it nearly impossible for healthcare managers to efficiently manage their resources. The decisions made based on inaccurate information, when the true cost of procedures and services is not known with a minimal degree of certainty, may harm the viability of the institution. As a result of all the above, the current healthcare market is under tremendous economic pressure. Many Health Maintenance Organizations (HMOs) suffer from financial difficulties. Their reimbursements are being reduced each year, revenues are down and profit margins are extremely low.

These circumstances have intensified the already rapidly growing need for an accurate and efficient cost analysis solution for healthcare providers, which will identify the real costs of the healthcare services provided to their clients. Such a solution should provide detailed cost information in order to provide accurate answers to questions such as “how much does it really cost to perform a glucose test on the Hitachi 911?” or “which CBC analyzer should be installed in a reference lab performing 500 tests per day?” Inside the various Information systems (IS) of every healthcare organization there are hidden valuable data, which with the appropriate tools, could be utilized in order to provide answers to the above questions. No such tools exist. As a result there is an urgent need for tools allowing cost analysis in the health care industry.

The present invention provides such new and novel tools. The present system seamlessly integrates with existing Information Systems for collecting real-time activity data (such as performance and consumption data) directly from the production floors. The data so collected, is then processed into valuable information by employing top-down cost analysis, taking into consideration the user's specific organizational structure and using novel allocation methods, unique to the present system and significantly different and much more accurate than standard allocation methods. Furthermore, the present application is preferably implemented within a framework of an Application Service Provider (ASP), embedded in a central computer platform, and accessible to users over a data communication network, such as the Internet or Intranet. The ASP approach imparts the application the ability to establish a healthcare industry data warehouse, which enables a continuous and comparative measurement of any healthcare procedure or service, and most importantly it allows industry benchmarking to all levels in the healthcare industry. Thus, the present invention enables any healthcare unit to analyze the true costs of performing procedures and delivering services in great detail, while at the same time benchmarking against an industry-wide data warehouse.

### SUMMARY OF THE PRESENT INVENTION

It is the general objective of the present invention to provide the healthcare industry with an accurate cost analysis system and method for medical products and services, which overcomes the disadvantages of the prior art.

It is another objective of the present invention to provide such a system, which has the ability to determine actual costs and profitability for all levels within a healthcare organization and which, unlike existing financial systems, employs terms and data familiar to healthcare providers.

Another objective of the present invention is to provide such a cost analysis system that will collect data from existing information systems (IS) in a healthcare organization, and will process the data into actionable information. It is yet another objective of the present invention to provide the healthcare industry with cost analysis tools, which utilize real data collected from the production floor in order to enable decision-makers to analyze the true costs of procedures and services provided to their clients, and to develop business strategies to improve profit margins. In particular it is an objective of the present invention to assist each individual patient care unit within an organization, and each responsibility center within a health care unit, in becoming an independent profit center.

A further objective of the present invention is to provide software tools that enable users to simulate and forecast the outcome of potential changes and alternative solutions in regard to their costs.

A further objective of the present invention is to establish a standard for healthcare procedure costing and to provide the healthcare industry with benchmarking services.

Yet a further objective of the present invention is to provide a healthcare portal, which offers diverse healthcare industry-related information and services and enables initiation of e-commerce directly from the point-of-need.

The foregoing objectives are met by the present system which allows an objective means for identifying, analyzing, and controlling the true cost of performing procedures and delivering health care services.

In accordance with the above objectives, the present invention provides method and system, especially designed for the healthcare industry, for enabling healthcare providers at all levels of the healthcare industry to calculate and to analyze the true costs of procedures and services provided to their clients. Based on the cost analysis results, users of the system (i.e., healthcare providers) can develop business strategies in order to improve profit margins.

One aspect of the present invention is a novel system and method for detailed cost analysis for providing cost-analysis and cost-control services to managers at all levels of the healthcare industry. The system utilizes real data collected from the production floor and processes the data into actionable true cost information by employing a top-down analysis methodology using novel allocation methods which takes into consideration the specific structure of the user's organization.

A second aspect of the present invention is a web-based application that interfaces directly and seamlessly with Patient Care level environments, collecting real activity data in real-time and enables access to a powerful and unique data warehouse for industry benchmarking.

In accordance with a preferred embodiment of the present invention there is provided within a data communication network having a computerized server system for providing activity-based cost-analysis and cost-control services for the healthcare industry, a system having a CPU and storage device, the system comprising a data exchange module for allowing the user to upload activity data into said computerized system, an analytical engine for processing the activity data, in accordance with the organizational structure and the product tree into product cost data. It may also include a setup module for allowing a user to define an organizational structure, product cost trees and user administration details. It can further include a repository database, the repository database includes healthcare related data including an analyzers list, a healthcare product list and pre-defined product cost trees corresponding to each of the products in the list, the setup means comprising accessibility to the repository database. It may also include a setup database coupled to the setup module for storing users organizational structure and customized user product trees. In addition it may include an activity database coupled to the data exchange module for storing users activity data, and a data warehouse for storing the product cost data. The data warehouse could be a multidimensional database. The cost product tree includes, in a hierarchical structure, the cost items associated with the production of the product and wherein each of the cost items is associated with a baseline quantity or with a formula for calculating the baseline quantity. The organizational structure is defined in terms of responsibility centers, workstations and products wherein each product is linked to a workstation or responsibility center and each workstation is linked to a responsibility center. The activity data includes consumption data, performance data, item price data and optionally, reimbursement data. The data exchange module includes means for allowing manual uploading of the activity data. The data exchange module may include means for allowing the user to define information source files residing in the user computer system, the information source files include user activity data. The data exchange module may connect to existing Information Systems residing in the user system for allowing automatic uploading of the user activity data into the server computerized system. The analytical engine may include algorithms for calculating the actual quantities of cost items comprising a product tree in accordance with the user consumption and performance data, whereby actual quantities are calculated by multiplying the baseline cost item quantity by the bias of the cost item consumption, wherein the bias is the ratio between the actual and expected consumption. In addition a cost analysis module can be included, the cost analysis module providing real time information generated by the analytical engine and stored in the data warehouse thereby providing the user with cost analysis information. The system may also include a simulation module, the simulation module providing information generated by the analytical engine and stored in the data warehouse thereby providing the user with simulations and budget forecasting. The system may include in addition a benchmarking module, the benchmarking module integrates data stored in the data warehouse and repository to display various unit comparisons.

In accordance with another preferred embodiment of the present invention there is provided within a data communication network having a plurality of healthcare providers computerized systems, a method implemented in a server computerized platform accessible to computerized systems by a browser or client software, for providing activity-based cost-analysis and cost-control services for said healthcare providers, the method comprising the steps of receiving and storing activity data in a database; upon receiving a request for cost analysis task from a user, processing the activity data in accordance with an organizational structure related data, to obtain cost analysis results in accordance with the cost analysis task; providing a user with setup module for collecting and defining an organizational structure, product trees and administration details; receiving the organizational structure related data of said user; storing the organizational structure related data of said user in a database; providing a user with a module to upload activity data at predetermined times into the server computerized platform.

The step of providing the user with a module to upload activity data may further include the steps of preparing the files to be uploaded by creating uploaded files description and configuring the upload process and uploading the files to the server; providing a user with a module to request various cost analysis, simulation, budgeting and benchmarking tasks; and sending results to a user over a data communication network.

In accordance with yet another preferred embodiment of the present invention there is provided within a data communication network a computerized organizational structure for storing activity-based cost-analysis and cost-control services for the healthcare industry, the organizational structure having a storage device and connected to a CPU, the organizational structure can include a responsibility center; for each responsibility center a workstation or a few workstations; and for each workstation a product cost tree or a few product cost trees, the product cost tree associated with cost items holding data relative to the product cost tree. The product cost tree may be a procedure defined by the quantity and allocation formula for calculating the cost of the procedure in relation to the cost item. Alternatively, the product cost tree may be a service defined by the quantity and allocation formula for calculating the cost of the service in relation to the cost item. The product cost tree may have one or more main cost categories and one or more sub level categories. Cost items may relate to direct or indirect costs and to fixed or variable costs. Product cost trees may also include information about quantity relating to a baseline quantity defined for the cost item(s) in the tree, and allocation basis formula for allocating costs associated with the cost item(s).

Additional objectives, features and advantages of the various aspects of the present invention will become apparent from the following detailed description.

### BRIEF DESCRIPTION OF THE DRAWINGS

The present invention will be understood and appreciated more fully from the following detailed description taken in conjunction with the drawings in which:

FIG. 1 is a schematic illustration representing the hierarchical structure of the healthcare industry;

FIG. 2 is a schematic illustration representing an overview of the cost analysis and cost control services provided by the present invention;

FIG. 3 is a block diagram of a system for cost analysis in the healthcare industry, in accordance with a preferred embodiment of the present invention;

FIGS. 4 is high level flow chart showing the main steps of the method in accordance with the preferred embodiment of FIG. 3;

FIG. 5 depicts the hierarchical structure of an organization as defined in accordance with the present invention;

FIG. 6 depicts the structure of a product cost tree in accordance with the present invention;

FIGS. 7A and 7B are an example for calculating an indirect cost item;

FIGS. 8A, 8B and 8C are exemplary screen shots of the setup module for allowing a user to define the organizational structure, cost items and product cost trees;

FIGS. 9A, 9B and 9C are exemplary screen shots of the data exchange module for uploading activity data into the system of the present invention;

FIGS. 10 to 16 are examples of graphic data output provided by the cost analysis, simulation and benchmarking modules;

FIG. 17 is an overview illustration of the entities and activities associated with the web-server in accordance with the present invention;

### DETAILED DESCRIPTION OF THE PREFERRED EMBODIMENT

The present invention overcomes the disadvantages of the prior art by providing a method and system for detailed cost analysis designed especially for healthcare providers at all levels of the healthcare industry. The approach taken by the present invention, in order to calculate the true cost of healthcare procedures and services is based on the Activity Based Costing (ABC) methodology. In accordance with this methodology the present system combines bottom-up data collection with top-down cost analysis. The invention is preferably implemented within a framework of an application service provider (ASP) over a data communication network, such as the Internet. However, it will be easily appreciated by persons skilled in the art that the present invention can be implemented in a local area network, Intranets and the like as well.

The application of the present invention provides healthcare providers with the capabilities of

i) analyzing and controlling the true cost of performing medical procedures and delivering healthcare-related services.

ii) Simulating and forecasting potential changes and alternative solutions

iii) Comparing performance with healthcare industry standards (benchmarking)

iv) Recommending cost-saving opportunities and changes to business processes, and

v) initiating e-commerce at the point of need.

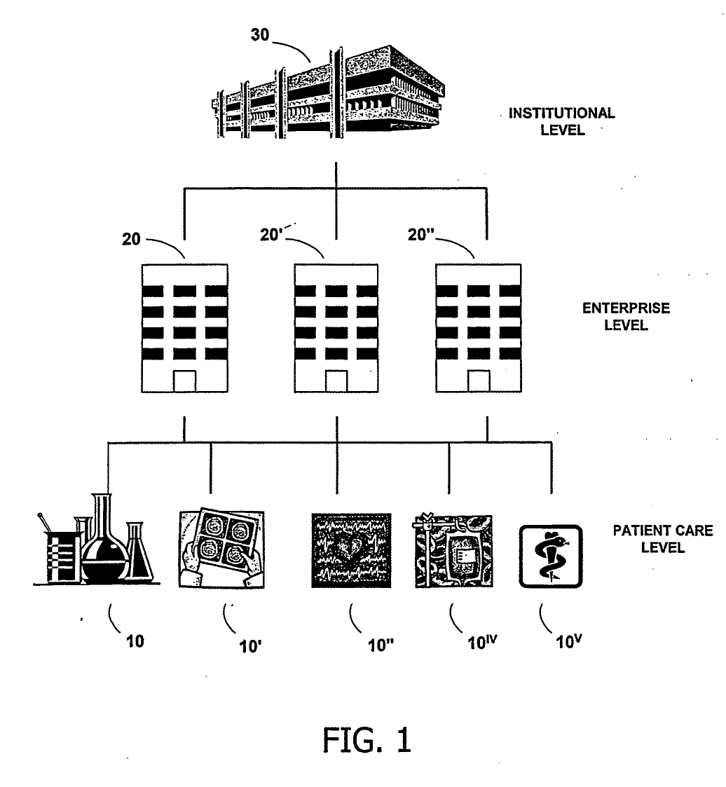

The hierarchical structure of the healthcare industry can be roughly represented by the three basic levels shown in FIG. 1. The lowest patient care level, includes “patient care units” 10 which provide services to patients. A “patient care unit” can be a laboratory, a radiology unit, a pharmacy, an operating room and the like. Above the patient care level, the enterprise level 20 consists of collections of patient care units such as hospitals. The top level is the institutional level 30 which includes hospital groups, Health Maintenance Organizations (HMOs), Preferred Provider Organizations (PPOs), and Integrated Delivery Services (IDSs). The present invention enables any healthcare unit to analyze the true costs of performing procedures and delivering services in great detail, while at the same time benchmarking against an industry-wide data warehouse. In particular, it assists individual healthcare units in becoming independent profit centers.

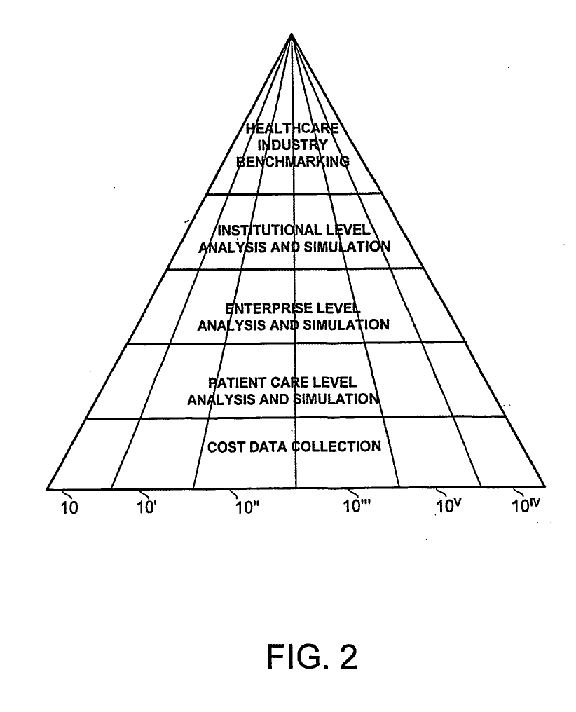

FIG. 2 schematically illustrates the tools provided by the present invention for different levels of the healthcare industry. By combining bottom-up real-time data collection from individual patient care units (designated 10) with advanced analytical tools, the present invention presents valuable costing information throughout the healthcare industry, both horizontally and vertically. Furthermore, the detailed cost data, gathered from lower levels is transformed to an online data warehouse which serves to validate and establish standard procedural cost data for benchmarking purposes and to continually improve the application's functionality. On the Patient Care Level the present invention provides analysis and simulation capabilities on direct and indirect costs, including labor, instruments, material, supplies and services. It enables each Patient Care unit to determine the true cost of all deliverables in order to improve profitability while maintaining high-quality care. One of the objectives of the present invention is to assist each individual patient care unit within an organization in becoming an independent profit center. The present invention provides accurate, real-time answers to important questions about each procedure or service provided by a specific care unit: How much does it really cost? Is it profitable? What is the ‘break-even’ point? Where is the most cost-effective site to perform it? What other alternative equipment could be used to improve performance and lower cost? What would be the results of increasing activity volume?, etc. Existing healthcare information systems do not provide accurate and timely answers to these questions. The present invention is particularly aimed at healthcare units such as a laboratory center, radiology center, surgery room etc.

On higher levels the present invention provides executives with the information needed to more effectively manage and forecast costs from an institution-wide perspective. At the Enterprise level it enables hospital directors to query an enterprise data warehouse, to perform cost analysis, simulation and benchmarking on a vertical basis or an intra-institutional basis. At the institutional level, it enables Managed Care executives to query the enterprise data warehouse in order to perform cost analysis, simulation and benchmarking investigation on a vertical basis and inter-institutional basis. It provides answers to questions such as: Which Patient Care unit in the enterprise is the most cost-effective for a certain procedure and why is it more expensive to perform this procedure in one Patient Care unit than in another? Would outsourcing be cheaper?

In order to provide all the above services, the present invention treats all performing procedures and delivering health care services as products and associates each product with a product cost tree which precisely defines, in a hierarchical manner, all the expenses associated with its production, down to the most basic items. In accordance with the present invention a product can be a test, a procedure or a service. For example in a laboratory, a product is a particular test while in a radiology unit or an operation room, a product is a particular procedure. A product may be an individual service or it may be a group of services delivered to a patient during an outpatient visit or inpatient stay, thus, a product can include another product. Furthermore, one product can be associated with more than one product cost tree according to its production procedure. For example, in a laboratory, a blood glucose test may have several different cost product trees, one for each of the analyzers on which the test can be performed. Preferably, the present invention uses standard codes, such as CPT codes, for classifying a healthcare product. This system of codes, generally referred to as Current Procedural Terminology, or CPT, was developed by the American Medical Association in conjunction with the Health Care Financing Administration, for the purpose of describing physician work for medical and surgical procedures, diagnostic tests, laboratory studies, and other physician medical services rendered to clients.

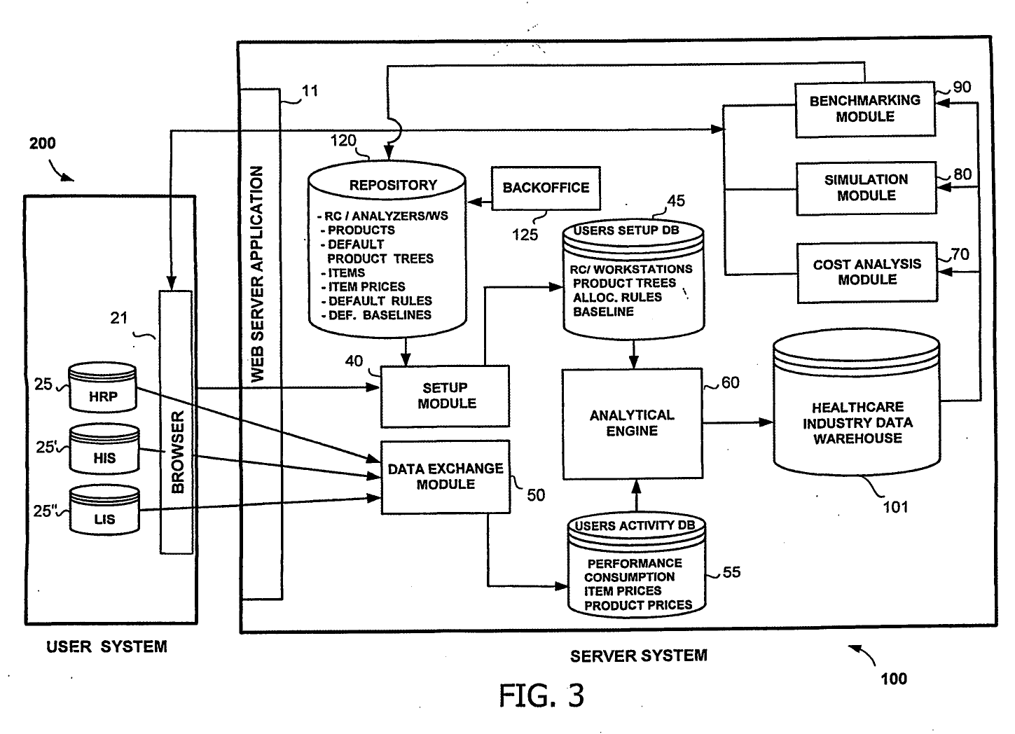

Reference is now made to FIG. 3 which represents an overview block diagram of a preferred embodiment of the present system. A more detailed description of each of the system components follows the overall general description. The application of the present invention is preferably implemented within a framework of an Application Service Provider (ASP) system embedded in a central server computer platform 100 having a network interface. Server platform 100, can be a single workstation computer such as a PC, a mainframe computer or a collection of computers interconnected by a local or wide area network. Server platform 100 is capable of handling web-enabled technologies by means of web server application 11 such as BEA WebLogic Server which supports Hypertext Transfer Protocol (HTTP). Such technologies include for example Java applets, JavaScripts, HTML, DHTML, XML, and the like on the client side, and Servlets, Java Pages (JSP) and Enterprise Java Beans (EJB) and the like on the server side. A user 200 of the system communicatively interfaces over a data communication network, such as the Internet or Intranet, to central server 100 by conventional communication devices such as a modem, a network card and the like, using a software application, i.e., Web Browser 21 (e.g., Microsoft Explorer, Netscape Navigator). User may access server 100 via other software applications such as a client software application specifically designed to interact with server 100. For the purpose of illustration Web Browser 21 is shown as the preferred embodiment in this document. Through browser 21 (in association with a display device and input devices such as a keyboard and mouse), a user can upload data into server 100 and can request and receive dynamic on-line information and services from the different server modules. It will be readily appreciated that server 100 may be located on a local area network within the organization of the user. Similarly it will be readily appreciated that a user may access server 100 not directly from user system 200 but from other “on the road” computing devices such as Laptops, Personal Data Assistance units and the like. The person skilled in the art will appreciate that other methods of data input and transmission between the user 200 and server 100 are contemplated by the present invention. Such can include manual delivery of data, delivery of the full IS (25, 25′, 25″) to server system 100 and the like. In yet another embodiment of the present invention the server 100 may reside within a user system 200 or within an Intranet or local area network relating to user 200 for local or single use by a user or a group of users. Alternatively the various components of the system may reside on various computers not limited in location or networks and connected there between via known data communication device creating a distributed network of computers providing the same functionality as shown in this invention.

As explained above, the approach taken by the present invention in order to provide true costing is to combine bottom-up collection of data directly from production floors with top-down analysis which takes into consideration the user's specific organizational structure. In accordance with this approach, system 100 contains two main modules for receiving user data, a Setup module 40 which is responsible for customizing the organizational structure related data, and a Data Exchange module 50 which is responsible for the collection of activity data from healthcare units. The organizational structure related data collected by setup module 40, defines in hierarchical manner the organizational structure in terms of responsibility centers (RC), the workstations (WS) under each of the RC, the products produced at each of the WS and the product cost tree associated with each of the products. An example for an RC is a Radiology Ward. An example for a WS is X-Ray machine or an Ultrasound machine. An example for a product is a Antero-Posterior Chest X-Ray film or any test preferably defined by the CPT. These definitions also include definitions for allocation rules at each of the organizational levels down to the lowest item level. The allocation rules include rules for allocating the cost components relating to each WS (later calculated to each product as per product usage).

Coupled to setup module 40 is Repository 120. Repository 120 contains healthcare related data such as lists of healthcare units, lists of healthcare products and most importantly pre-defined default product trees including allocation rules. The information stored in repository 120 is accessible to users during the setup stage for facilitating the definition of the organizational structure and product cost trees. When a user specifies a particular product produced at a specified workstation, the product is automatically associated with the corresponding default product tree from repository 120 and with a standard baseline cost associated with said default product tree. The user can leave the product tree without a change, saving the default standard as the baseline, or can customize the product tree and consequently the baseline. The data contained in repository 120 is maintained and can be altered only by managers of the system through Back-Office module 125. It is important to note that although the data is fully accessible to users of the system, it is optionally protected and cannot be modified by the users. The user specific setup data, which can be modified by the user at any time, is stored in users database 45. However, based on the constantly updating statistical data, which accumulates in the data warehouse 101, the system managers can update various data elements and consequently cost standards. The activity data collected from healthcare units (i.e., the healthcare industry production floors) by Data Exchange module 50 includes time dependent production, consumption and pricing data. Preferably, Data exchange module 50 collects data directly from existing client information systems, designated 25, such as LIS (Laboratory Information System), HIS (Hospital Information System), HRS (Hospital Resource Planning) and the like, via Web Browser 21 and the like client software modules. Information may also be directly uploaded to the Data Exchange Module 50. In order to facilitate rapid integration with the client's ISs, module 50 includes a set of conversion programs for importing data from external ISs.

In accordance with the preferred embodiment, two databases, users setup database 45 and users activity database 55 are coupled to modules 40 and 50 respectively, for storing the users input data. Databases 45 and 55 are preferably handled by RDBMS (Relative database Managing System) or ODBMS (Open database Managing System) and the like. From setup database 45 and activity database 55, the user setup and activity data is transferred into Analytical Engine 60 to be processed into actual “true” costs specific to that organization. Analytical engine 60 includes a set of algorithms for processing the actual data collected in accordance with the organizational structure and rules provided by the user setup data. Thus, the consumption and performance data provided by the user is allocated to the organizational structure elements in a “diffusion-like” manner from the input level to the lowest level of basic items, giving each element its appropriate “share”. The actual product cost is then calculated by summing up all the product tree elements. The actual cost data so obtained is transferred into Data Warehouse 101. Warehouse 101 is a multidimensional database, managed by database management tools such as provided by Oracle, containing users historical and current cost data, which allows On-line Analytical Processing (OLAP) and sharing information between users.

User application modules, such as cost analysis module 70, simulation module 80, and benchmarking module 90 are coupled to Data Warehouse 101, and provide users with cost-analysis and cost-control services. Cost analysis module 70 analyzes the operational costs and presents numerical and graphical displays of costs. Cost analysis module 70 is provided by information from the data warehouse 101 as generated by the analytical engine 60. Cost analysis module enables users (such as executives) to compare costs within and between different units to make strategic decisions. Simulation module 80 simulates various scenarios and enables budget forecasting. Simulation module 80 is provided by information from the data warehouse 101 as generated by the analytical engine 60. Benchmarking module 90 integrates data stored in the data warehouse 101 and repository 120 to display various unit comparisons. These modules are implemented using web technologies such as Java Applets, JavaScripts, DHTML and XML and the like for enabling Graphical User Interface (GUI) display and by the use of tools such as DataBeacon OLAP applets and the like for enabling analysis of OLAP data. One of the important advantages associated with the ASP nature of the present system is the advantage of being updated constantly upon user's input. Thus, the information stored in warehouse 101 increases over time and is updated continuously. Based on this constantly accumulating information, system 100 further includes benchmarking module 90, which offers users industry benchmarking services.

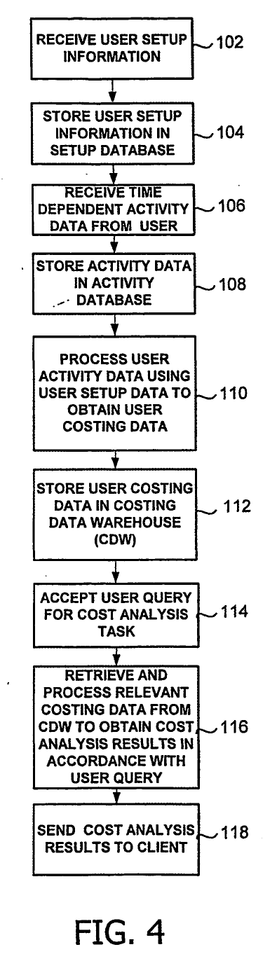

Referring now to FIG. 4 there is depicted an overall flow chart showing the main steps of the present method in conjunction with the preferred embodiment of FIG. 3. Prior to normal operation with the system 100 a user must go through a setup process. When a user (like user 200 of FIG. 3) connects to the application 11 for the first time, the first step to be done is to define the organizational structure (step 102). During the setup phase, the user provides setup module 40 with the detailed hierarchical structure of the user organization. Users are provided with user-friendly setup tools for defining their organizational structure in terms of responsibility centers, workstations operated under each of the responsibilities center, products produced by each of these centers and product trees for each of said products. The user setup information collected by setup module 40 during the setup process is stored in setup database 45 (step 104). Upon the user request median data will be provided from the repository 120. Such data is provided to assist the user in determining the appropriate data required during the setup stage in formulating the various product trees. For example, if a specific user provides that in a particular laboratory (a responsibility center) there exists a particular workstation, such as an ABS 2000 Analyzer, the product trees for the ABS 2000 may be supplied to the user through the repository 120 by the setup module 40.

The next steps, 106 and 108, after the configuration of the client's organization has been completed and stored, are to collect and store the activity data. This is done by means of data exchange module 50. The user activity data collected by the data exchange module 50 is stored in the users activity database 55. It should be emphasized that the process of uploading activity data into module 50 can be done intermittently at the user convenience. Furthermore, different “pieces” of activity data, e.g., performance and consumption, which arrive from different IS in user system 200 need not be uploaded synchronously and can be uploaded separately, at the user's convenience. However the periods, i.e. starting date and ending date to which the activity data relates, must be specified. For example, if in a certain organization, performance reports are prepared on a daily basis while consumption reports are prepared on a monthly basis, performance data can be uploaded into module 50 every day and consumption data once a month as long as the periods are defined clearly. Although the setup input and the activity input steps are described here in a sequential order, a user can build up his system gradually by adding more units and products setup definitions over time. Thus, in order to start working with system 100, a user must first provide at least a “draft’ setup configuration, then he can customize the setup configuration over time as he learns more about the system. Once the user activity data has been uploaded into data exchange module 50, the activity data is transferred to the users activity database 55 and then provided to the analytical engine 60 to be processed in accordance with the user setup data to obtain the user costing data for each of the products specified in the setup data (step 110). The costing data is then stored in Warehouse 101 (step 112). Steps 110 and 112 are repeated each time a user enters new activity data.

Now system 100 is ready to process user requests. Upon receiving a request for cost analysis task (step 114) the relevant data is retrieved from warehouse 101 and is processed in accordance with the specific task by the appropriate user application module (step 116). The results are sent to user system 200 (step 118) to be displayed at user system 200 by means of browser 21.

In the following, preferred embodiments of the different modules the system, as well as other aspects of the present system, are described in detail.

Setup Module

1. Organizational Structure

System Setup module 40 is where the basic elements of the system, such as resource, users, roles, and authorizations are defined. Once authorizations are defined, the setup module enables authorized users to quickly and easily perform the initial setup of their organizational structure.

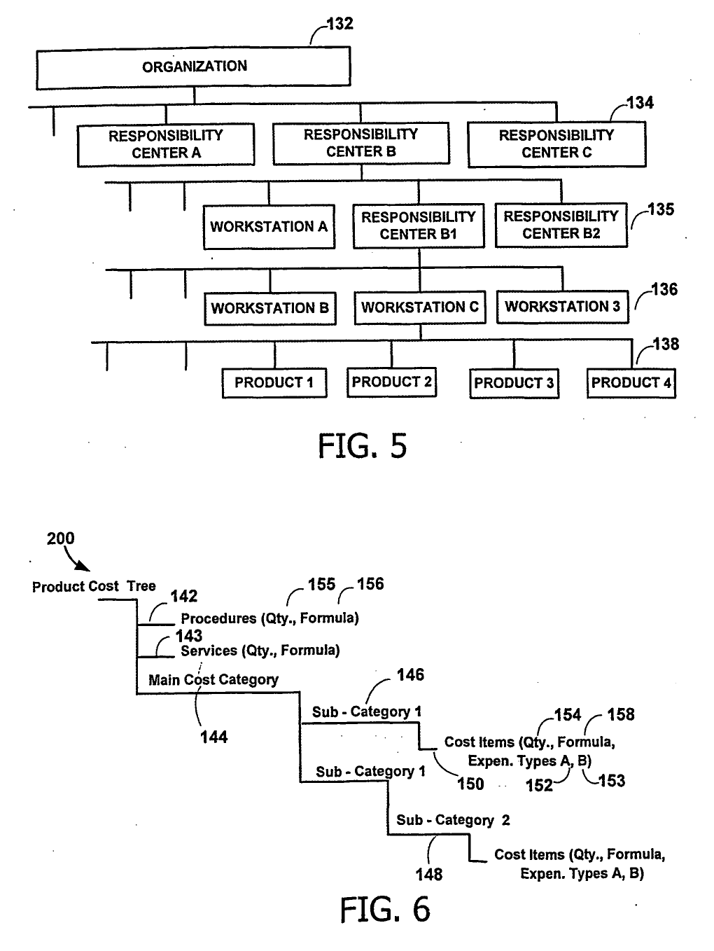

FIG. 5 shows the hierarchical structure of an organization as defined in the setup module. In accordance with the present invention, the hierarchical structure of an organization (132) is defined in terms of responsibility centers (RC, 134, 135), workstations (WS, 136) operating under each RC, products (138) produced by each WS and the associated product cost trees PCT). For example, in a laboratory, a responsibility center would be a certain section of the laboratory, e.g., hematology lab, a workstation would be a specific analyzer, e.g., Pentra ABX 60, a product would be a certain test, e.g., CBC. In a surgical center, a responsibility center would be a group of operation rooms, a workstation would be a specific operation room and a product would be a specific surgical procedure, e.g., by-pass etc. As can be seen in FIG. 5, a responsibility center can be higher in hierarchy to other responsibility centers. However a workstation can only have products.

2. Product Cost Trees

According to the present invention, the cost of any product (i.e., procedure or service) is “drilled down” or “factorized” to the level of cost items. Thus, each “product” is associated with a product cost tree which is composed, in a hierarchical structure, from all the costs associated with the “production” of that particular product, down to the most basic cost items.

FIG. 6 depicts a model for the structure of product cost tree 200 and the data it holds. According to the present invention, each Product cost tree 200 holds data for a specific Product 138 produced at a specific workstation. A product might have more than one product cost tree wherein each of the trees is associated with a certain workstation. Product tree 200 may comprise another product, such as a procedure 142 or a service 143, which is defined by the quantity 155 and the allocation formula 156 for calculating the cost of this procedure (or service) in relation to product 150.

The product cost tree depicted in FIG. 6 consists of four layers of data: Main cost categories 144, two levels of sub-categories 146 and 148 and cost items 150 at the lowest level. Preferably the main cost categories are defined by the system and cannot be modified by the user. Table 1 lists an example to a set of main cost categories with arbitrary examples of different items belonging to each main category.

TABLE 1
Main categories of a cost object tree

| | Examples for main category |
|---|---|
| MAIN CATEGORY | items |
| Labor | Direct labor: |
| | Salary lab techs. |
| | Indirect Labor: |
| | Salary lab manager |
| | Salary clean up |
| Materials | Reagents |
| | Disposables |
| | Materials for equipment |
| Contracted services, | Shipping |
| | Waste disposal |
| | Laundry |
| | Software & hardware tech. |
| Maintenance, | Facility cleaning |
| | Facility supplies |
| | Facility repair |
| | Rewriting |
| | Remodeling |
| Equipment/ | Time equipment was used |
| Depreciation | Software licensing |
| | Capitalization |
| | Lease payments |
| Supplies | Consumables |
| | Disposables |
| | Alcohol |
| | Distilled water |
| Overhead | Rent |
| | Heat |
| | Electricity |
| | Admin. Salaries |
| | Communication |
| Other | Deliveiy cost |
| | Batteries |
| | Taxes |
| | Various supplies |

In the embodiment described in FIG. 6, the system allows defining two levels of sub-categories 146 and 148. The sub-categories are “flexible” to the user and may be added, changed and deleted during the setup. The lowest level of a product cost tree consists of cost items 150.

From Table 1, it is obvious that some of the items in the second column, such as reagents and disposables, relate to direct costs while other items, such as rent and electricity, relate to indirect costs. Direct costs are costs that are directly traceable to the production of the product, indirect costs are costs that contribute to the overall expense of running the organization or the responsibility center but cannot be directly traceable to the product production. Costs can also be classified according to another classification as “fixed” or “variable”. Fixed Costs are costs that do not vary with changes in the volume. Variable Costs are costs that vary with changes in the volume of the Product produced. Accordingly, each cost item is defined according to these two classifications, as a direct/indirect cost (designated here as expenditure type A 152) and as a fixed/variable cost (designated here as expenditure type B 153).

The actual cost of each item is calculated in accordance with a predetermined set of rules and formulas. Accordingly, each cost item in the product cost tree is further defined by its quantity 154 and formula 158 for allocating costs associated with the cost item. Quantity 154 relates to the baseline quantity of the particular item 148 needed to produce the product and is defined in terms of units such as ml, hours, etc. Formula 158 defines the allocation rule for calculating the baseline quantity and later, the actual quantity of item 150, in accordance with the user activity data. For example, one such formula provides the allocation basis for calculating an Employee's Hours Per Product. Other formulas may include Machine Time Per Test, Machine Operators' Hours Per Test, Hours of Equipment Per Test, Calibration Hours Per Test and the like. During the Setup stage the user may define allocation rules associated with each level of the cost object tree.

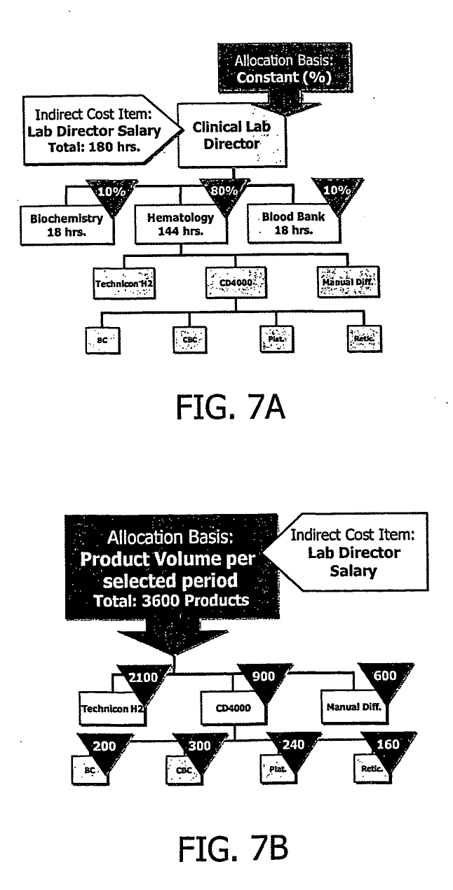

FIGS. 7A and 7B show an example for an allocation rule defined during the setup phase. The example is for calculating the baseline quantity of Lab Director hours per Product. The calculation is done in two steps. FIG. 7A shows a section of organizational structure starting at RC “clinical Lab Director” which is responsible for three sub-RCs: “Biochemistry”, “hematology” and “Blood Bank”. The “Hematology” RC includes three WS: “Technicon H2”, “CD4000” and “Manual Diff”. WS “CD4000” produces four products: “BC”, “CBC”, “Plat” and “Retic”. In the example shown here, the allocation basis for splitting cost item “lab director salary” at the sub-RC level is a constant percentage, wherein the weights assigned to the three sub-RCs are 10% to “Biochemistry”, 80% to “Hematology” and 10% to “Blood Bank. In the example shown here the Lab Director works 180 hours per month, then according to the above weights, the Lab director hours are allocated as follows: Biochemistry: 180*10%=18 hours; Hematology=180*80%/=144 hours; Blood bank=180*10%=18 hours.

FIG. 7B shows the allocation rule for calculating cost item “Lab director Salary” at the Hematology RC level. The allocation basis in this case is Product Volume per selected period. In the example shown here the total number of products produced at the Hematology RC is 3600 (the numbers at the triangles indicating the quantities). Thus, the baseline quantity for Lab Director is 144 hrs/3600 products=0.04 hrs. per Hematology RC product (e.g. CBC). The result of the setup process is a “Cost Object Tree” (COT) for each product defined by the user. Each COT is linked to the responsibility center in which it is produced and includes all the identifiable resources required to produce that product and the associated rules for calculating allocations. The COT defined at the end of the setup is associated with the baseline cost. It can be identical to the default tree supplied by the system, it can be a draft tree or a customized tree.

As mentioned above, the setup module is coupled to repository 120. During the setup phase, the system offers the user menus for selecting units and items at each level of the organizational structure down to the lowest level of a product tree. A user can choose between selecting a predefined item from said menus or defining his own units and items. Once a user specifies a particular workstation, the system provides him with a list from repository 120 of possible products produced at that particular workstation. Once a user specifies a particular product, for instance, in terms of its CPT code, the system provides him with a suitable pre-defined (default) product cost tree from repository 120. A user can use a default tree as it is or can customize it, by user-friendly tools, in accordance with the specific procedure used by the user. The customization process, if required, can be done gradually over time. According to one embodiment of the present system, at least part of the setup information is captured semi-automatically from the ISs of the user residing in system 200. For example, list of analyzers employed at each responsibility center (RC), test names and prices can be uploaded directly from the user's IS to the repository 120 or entered manually by the user 200 to the repository 120 via the browser 21 employing server application 11.

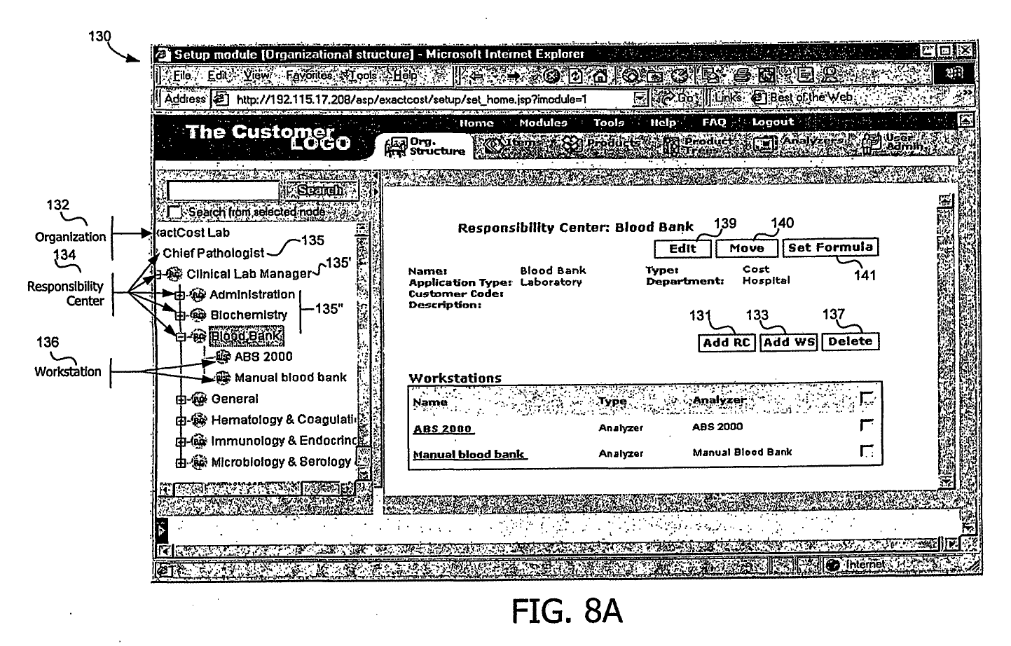

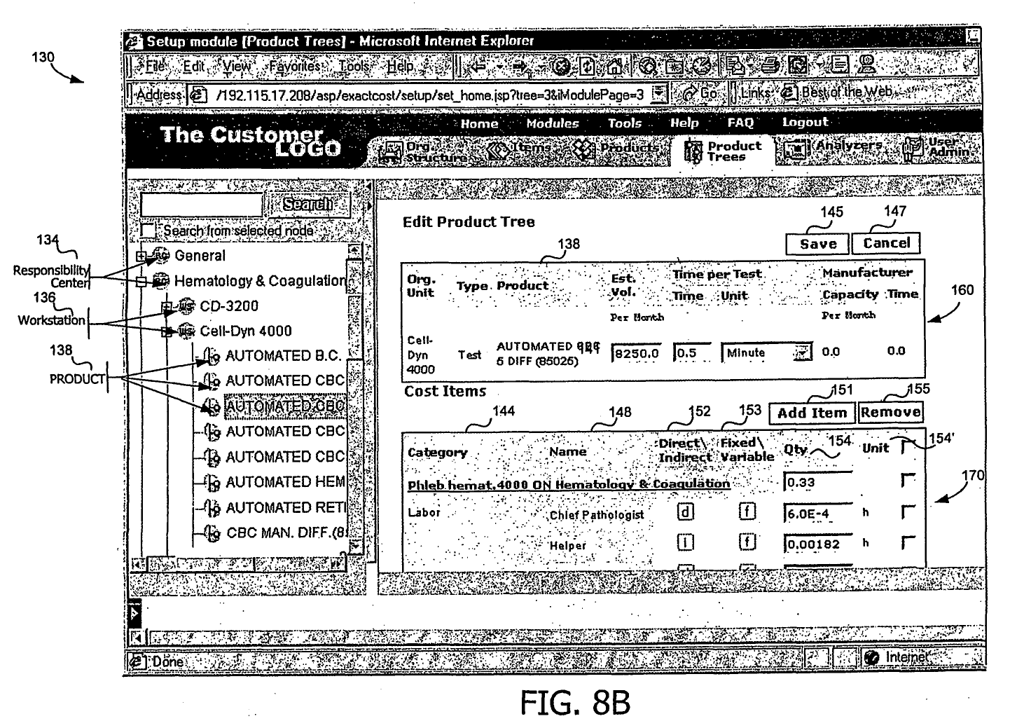

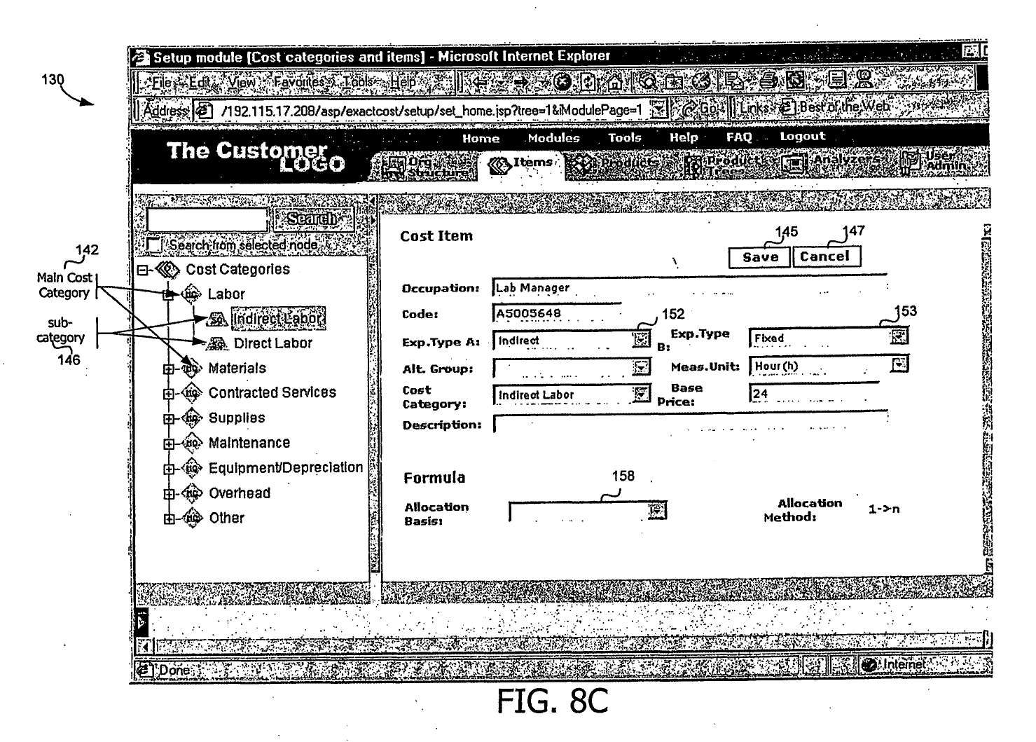

FIGS. 8A, 8B and 8C are exemplary screenshots of a graphical user interface (GUI) 130 for facilitating an easy definition of the organizational structure, product trees and cost items, respectively. The GUI 130 comprises operative windows in which the user may view and interact directly with the operative software running the application embodying the present invention in connection with computer systems. GUI 130 is shown by browser or client software 21 (of FIG. 3) accessing server application 11 (of FIG. 3) and the relevant modules (such as setup module 40 and data exchange module 50) within server system 100 (of FIG. 3).

FIG. 8A is a screenshot of GUI for facilitating building of the organizational structure. A user can define the responsibility centers 134 and workstations 136 by clicking the add RC and add WS buttons 131 and 133. Upon clicking, a pull-down menu (not shown) is opened displaying a list of RC or WS, from which the user can select the appropriate item. Clicking edit button 139 allows the user to fill in the relevant details, such as name of the RC, Application Type, Customer Code, Description, Type, Department and the like. A user can delete a responsibility center or a workstation, or move them to another location in the organization tree by means of buttons 137 and 140 respectively. Button 141 “set formula” allows the user to define the allocation basis and formula for the cost items as explained above. A following screen (not shown) allows the user to select from a pull-down menu the products produced at each of the workstations. In the present example the organization name is “ExactCost Lab” 132 having a hierarchical structure of three levels of responsibility centers 134. The main RC shown here is “Chief Pathologist” 135 responsible for “Clinical Lab manager” RC 135′ which in its turn is responsible for a group of RC 135″: “administration”, “biochemistry”, “blood bank”, “general;” etc. “Blood bank” includes two workstations 136 “ABS 2000” and “manual blood bank”. In the example shown here, the “blood bank” RC is selected, showing the two WS 136 included under it: The RC's details and the workstation are shown on the upper side of the right hand window providing the type of each RC. It will be appreciated by those skilled in the art that similar pointing and selecting a particular item (whether a RC, a WS or a Product) on the left hand window will provide various information on the right hand window about the selected item.

Likewise, FIG. 8B is an exemplary screenshot of GUI 130 for facilitating defining a product tree. The left window shows a section of the organizational structure down to the level of products 138. On the right window the corresponding details of the selected WS (“Automated CBC” in the example) are shown in tables 160 and 170. Table 160 gives the details of the WS, the product and the estimated volume of products per month and time per product. The Manufacturer estimation can be given as well for comparison. A user can change these details and save or cancel the modifications by means of buttons 145 and 147 respectively. Table 170 gives the product cost tree of the selected product in accordance with the product cost tree of FIG. 6. A user can add an item or remove an item by clicking buttons 151 and 155. When choosing to add an item by clicking button 151, a list of items is displayed (not shown) from which the user can select the appropriate item. In the present example the Automated CBC 5 DIFF product 138 is selected. In the right hand GUI window table 160 shows that the WS for the product 138 is Cell-Dyn 4000, that the product is a test. Also shown is particular information such as the estimated volume of the product used per month (8250 products) and the time per test (½ a minute). Table 170 shows the particular cost items associated with product 138 shown in table 160. Table 160 shows each cost item quantity 154 and the unit of measurement 154′ for the particular cost item category 144 and cost item sub category 148 shown. One example of such cost item category is the “LABOR” cost item category. Under the LABOR cost item category the “Chief Pathologist” and a “Helper” are shown as cost item sub categories. Also shown is whether each cost item is calculated as a direct or an indirect cost 152 and whether such cost item is a fixed or variable cost 153. FIG. 8C displays a following GUI screen by which the user can define the details of each of the cost items, such as the expenditure type 152, 153 and allocation basis 158. Other detailed may be entered at this stage to further facilitate a more accurate description and definition of the particular cost item. Such may include the occupation of the particular person (that is part of the labor category), a code associated there with, measurement units, cost category, base price, additional description and the like. As explained above each one of the particular entries (including cost item particulars) may be updated and changed by the user at the setup stage. It will be appreciated that in association with other cost categories and sub categories various other information that relates to each product and cost item may be entered to accomplish the cost analysis of the present invention. Such can be appreciated from Table 1 shown above.

Data Exchange Module

In order to calculate the actual costs of products provided by a user, the present system requires the following external activity data from the user system: 1) Performance (i.e., how many tests were performed per period); 2) Resource consumption (i.e., what quantity of items was used per period); 3) Item prices (i.e., the prices of the item used); 4) reimbursement (i.e., what is the fee received for each of the products). It should be noted that the last data item, i.e., product prices, is only optional. If is not necessary for the actual cost calculations. When the configuration of the user organization has been completed and stored in the setup module, the system is ready for collecting activity data from user system 200, by means of data exchange module 50. Data Exchange module 50 seamlessly interfaces with existing client ISs 25, 25′, 25″, such as LIS (Laboratory Information System), HIS (Hospital Information System), HRS (Hospital Resource Planning) and the like, for capturing detailed performance, resource consumption, and items prices data, via Web browser 21 thus facilitating quick data uploads. In order to facilitate rapid integration with the client's ISs 25, 25′, 25″, the Data Exchange module 50 includes a set of conversion programs for importing data from external ISs, thus significantly shortening the implementation time. Data Exchange module 50 is capable of extracting data from different types of sources: Relational databases, flat files in different formats (ASCII fixed length, ASCII with delimiter, etc.). The user files are first uploaded by means of browser or client software 21, then the received data is loaded into users activity database 55 where it is stored in accordance with the database structure. Uploading data from client system 200 to server 100 is preferably done in two phases. The first phase is the initial import set-up, which is done once for each imported file type and allows the user to define the exchange specifications. The second phase enables a periodic import by means of a Batch Manager which allows the user to define scheduled times for running jobs. However, if the user cannot create and upload data files, the system allows him to enter data manually. In the first setup phase of the data exchange module 50, the user prepares the files to be imported from his system 200, by creating the imported files description and configuring the import process to be executed automatically or semi automatically on the local system. With the aid of a File Specification Wizard, a user defines his IS files in terms of a description of the file type, the file location on the client environment and the file identification. Part of the data is saved in the application and local data is saved on the user's computer. During this set-up process, data exchange module 50 sets pointers to the physical location of the data files and look-up tables of the client's ISs. This information is used upon future requests to update cost data. At the second phase the files are imported to the server periodically. This can be done (a) automatically by an automatic execution process on the user machine which is synchronized with the process scheduling (b) semi-automatically by executing the “import to application” module explicitly (c) manually by feeding the data into the application through a special module or (d) by sending the data files by e-mail. Data exchange module 50 is compliant with ASCII files and XML communication standards and includes a set of conversion programs for importing data from external IS files. The data entries captured by module 50 are divided into data types such as cost item prices, performance, consumption and optionally product price list. Typically, LIS files contain performance data while HIS files contain accounting, consumption and inventory data. The raw data, thus captured is processed, rearranged and inserted into the appropriate locations in activity database 55.

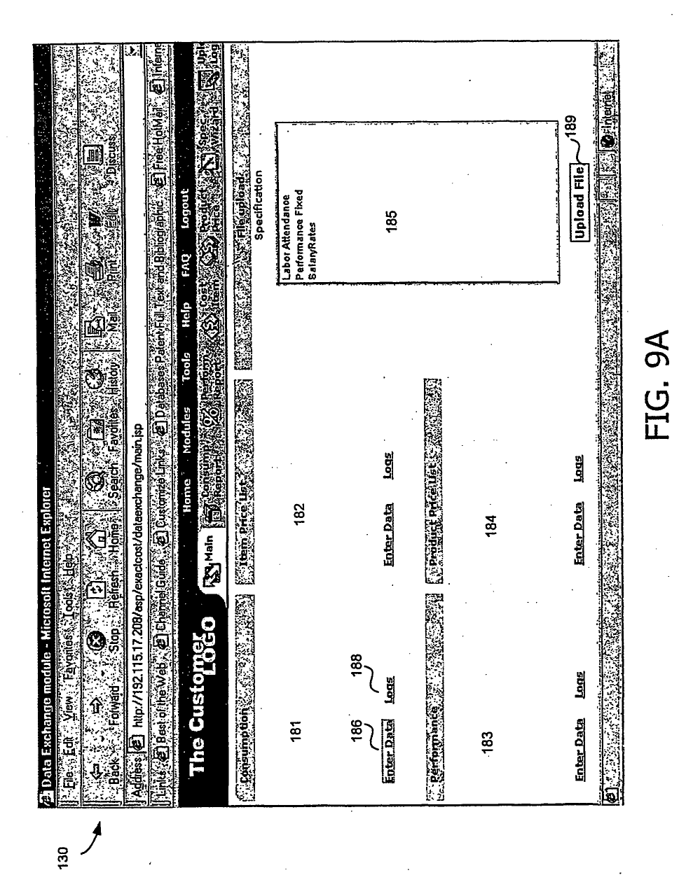

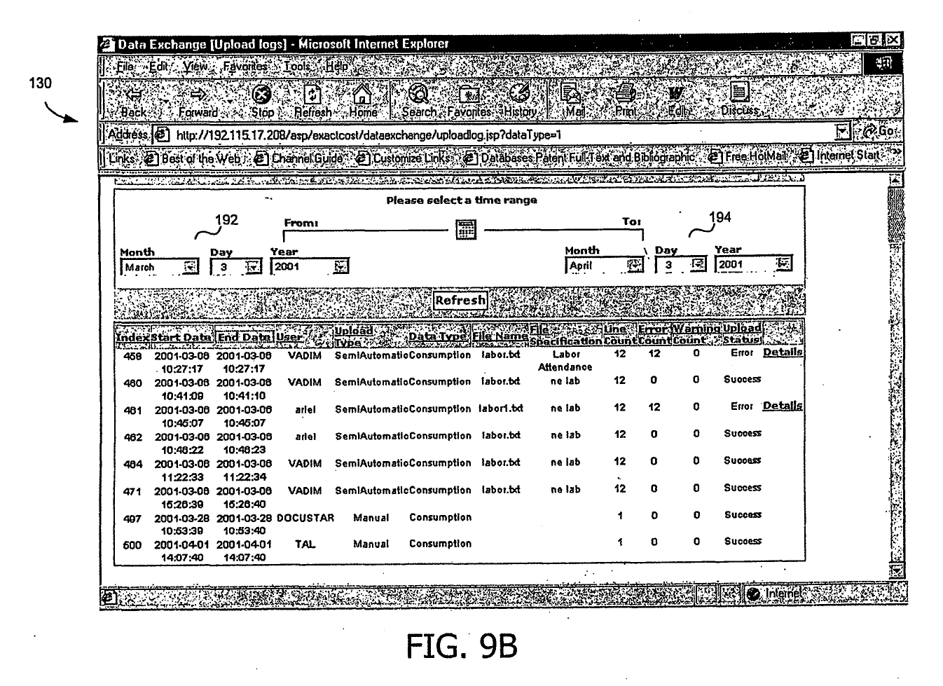

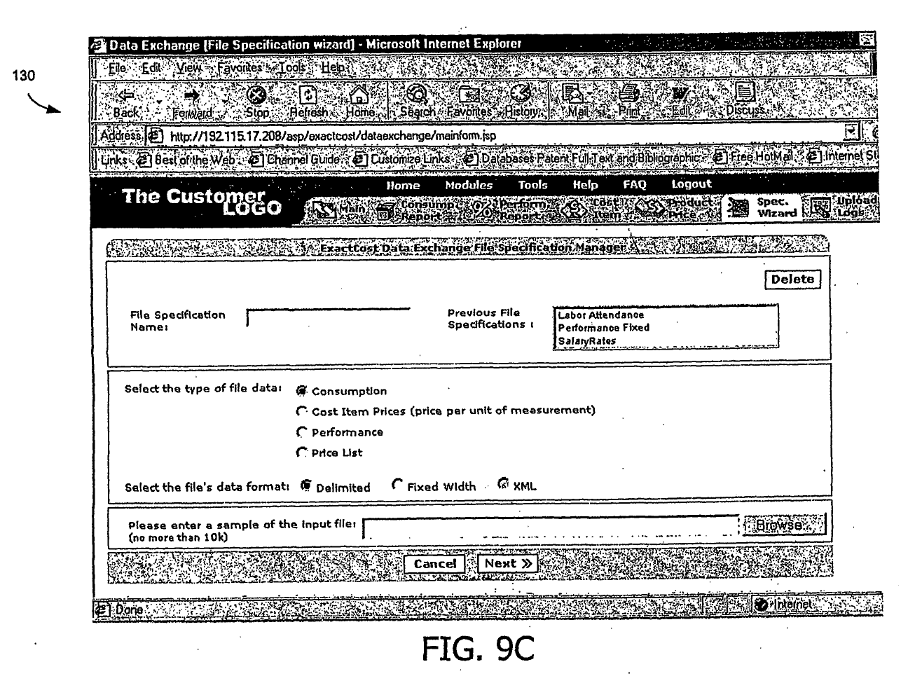

FIGS. 9A, 9B and 9C are exemplary screenshots of the graphical user interface (GUI) of Data Exchange module 50, for facilitating an easy definition of the uploading procedures in accordance with the above description. FIG. 9A shows an example of a main interface of the data exchange module 50. The GUI 130 is divided into five sections. Sections 181, 182, 183 and 184 correspond to the four types of activity data needed in order to perform cost analysis, i.e., consumption, performance, cost item prices and product prices. Section 185 displays a list of information source files residing at the user system. By clicking “enter data” button 186 a user can upload information manually to any of the four categories, or alternatively can upload the relevant data from one of the files specified in window 185 by clicking “upload file” button 189. Clicking “logs” button 188 opens a new screen, shown in FIG. 9B, displaying a history list of uploading data in a defined period, allowing the user to define the period by starting date (192) and ending date (194). Additional information may be provided can include index number, start date of information, end date of information uploaded, name of user performing upload, upload time (Manual, Automatic or Semi Automatic), data type uploaded, name of file uploaded, the number of lines in the file uploaded and the number of errors and warnings encountered during the upload, a general status for the upload (error or success) and the like.

FIG. 9C shows an example of a “file specification wizard” interface for facilitating a definition of an information source file. By means of this interface a user can browse through his files, choose a specific file from his file system (using the “Browse” button) and then defines the type of data stored in that file and the file format in order to map the source fields to the target fields. Once the user defines an information source file the settings are saved for future use. When selecting the “upload file” button 189 (in FIG. 9A) the relevant data is uploaded automatically in accordance with the file specifications.

Analytical Engine

The analytical engine 60 is a computer program module for calculating actual quantities of the cost items of a Product. Analytical engine 60 is based on an activity-based costing (ABC) methodology, which captures and identifies the true quantities involved in performing each procedure and/or test in a department, based on actual performance and resource consumption.

Analytical engine 60 includes a set of algorithms for processing user activity data in accordance with the organizational structure and rules provided by the user setup data. These algorithms are used for calculating the actual quantities of both direct and indirect cost items. In general, actual quantities are calculated by multiplying the baseline cost item quantity (as set in the Setup module) by the bias of the cost item consumption, wherein the bias is the ratio between the actual and expected consumption.

Table 2 is an example demonstrating the calculation method for a case where a certain cost item, I1, participates in the production of three products, each having a corresponding product cost tree and all produced by the same workstation, WS1. The table summarizes the raw data as collected by setup module 40 and data exchange module 50, sent to users activity database 55 and the calculated data as was processed by the analytical engine 60.

TABLE 2
an example for calculating actual quantities of a cost item.
The actual consumption (AC) of I1 by WSl in this example is
396 units. The value of AC is extracted from the
user consumption report.

| Tree | ¹BIQ | ²AVT | ³BIQ * AVT | ⁴AIQ |
|---|---|---|---|---|
| Tree 1 | 0.2 | 200 | 40 | 0.24 |
| Tree 2 | 0.3 | 300 | 90 | 0.36 |
| Tree 3 | 0.4 | 500 | 200 | 0.48 |

¹biqᵢ are the baseline quantities of item I1 in each of the corresponding
frees. The values of BIQ were set during the setup phase and are taken
from the setup database 45.
²avtᵢ are the actual volume of each free, i.e., the number of times the
procedure or service associated with the tree, was produced. The AVT
values are extracted from the user performance report (within the users
activity database 55).
³avtᵢ * biqᵢ, are the calculated expected consumption quantities
of item I1.
⁴aiqᵢ are the calculated actual quantities of item I1 per product for
each of the three products:
${aiq}_{i} = \frac{ac}{{\sum }_{i} {avt}_{i} * {biq}_{i}} * {biq}_{i}$

In order to calculate the actual quantity of item I1 per each product, the actual total consumption (AC) should be split between the three trees. This is done by multiplying the baseline quantity of I1 in each tree, biqᵢ, by the ratio between the actual consumption (AC) and the total expected consumption, Σavtᵢ*biqᵢ, at WS1.

In the example given in table 2 the total expected consumption of item I1 by WS1 is 330 units while the actual consumption as reported by the user consumption report is 396. The bias is therefore 396/330=1.2, and the actual quantities of item I1 in each of the three products is calculated to be, 0.24 (0.2*1.2), 0.36 (0.3*1.2) and 0.48 (0.4*1.2), respectively.

From the example given above, it will be easily appreciated by persons skilled in the art that the calculation of the actual quantities depends on the level at which the actual consumption is reported. Thus, if in the above example, the level of consumption report was one level higher, i.e., at a responsibility center which includes a number of workstations, each producing a number of products in which item I1 participates as cost item, the bias will be calculated by dividing the reported consumption by the total expected consumption at the responsibility center level. On the other hand, if the consumption report is at the product level, then the actual quantity is calculated simply by dividing the consumption by the actual volume. Accordingly, the set of algorithms, included in the analytical engine 60, take into consideration, for each resource, the level at which the actual consumption of that resource is reported.

Application Services

The application services modules, use OLAP tools for analyzing the data stored in multidimensional data warehouse 101, thus enabling users to study different dimension of said data. Queries received by users, through browser or client software 21, are processed at server 100 side, by said OLAP tools and the analysis results are sent to users via the browser using various web-technology tools, such as DHTML, XML, Java Applets, etc., to be displayed in the user system 200.

1. Cost Analysis Module

The primary function of cost analysis module 70 is to present the actual cost of performing procedures, tests and other patient care processes and to provide comparative views of those actual costs to a user selected standard (internal baseline or regional, national and international standards). Cost analysis module 70 analyzes operational costs calculated from the user selected/defined cost object trees and presents a graphic and numeric display of various cost comparisons. It also displays traditional standard financial reports and factual graphs that identify operational break-even points, profits and losses. The calculated costs are updated dynamically each time data exchange module 50 is uploaded with new data. Cost analysis module 70 allows users to “drill down” the true cost of each product provided by the user, in order to view the costs at the lowest level. For example, a manager in hospital administration could view the cost of performing any single test in any of the laboratories in the hospital at any given time. The cost shown may include the direct, indirect, fixed and variable costs involved in performing that specific test, on a specific instrument, at a specific location. This provides valuable information that can be used to determine more cost-effective work distribution policies. A user can also compare current cost information with historical cost information from previous months, quarters, years, and the like.

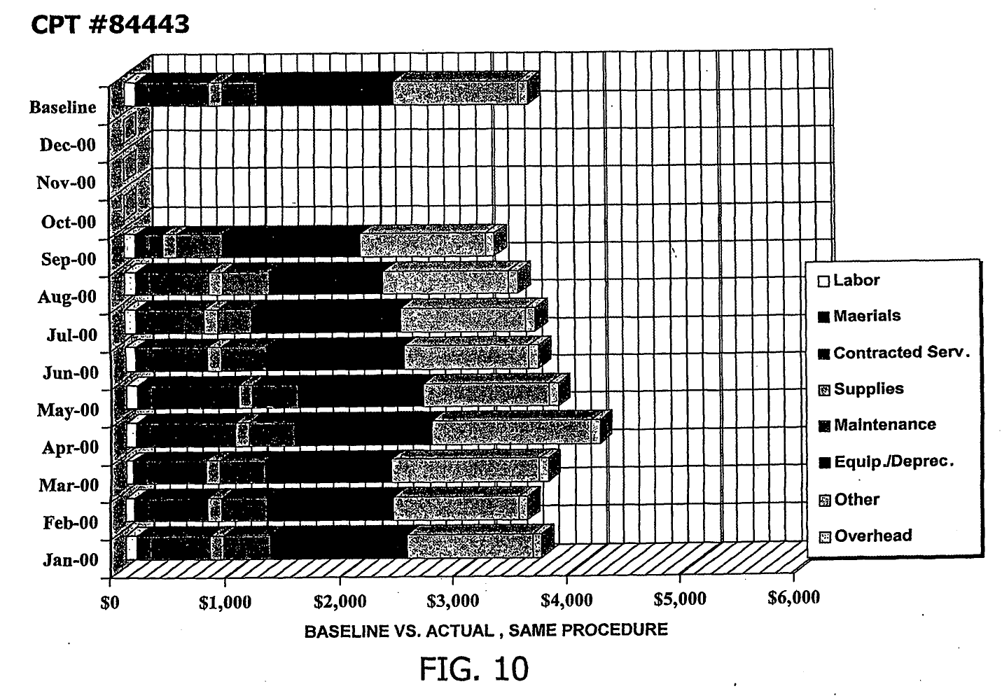

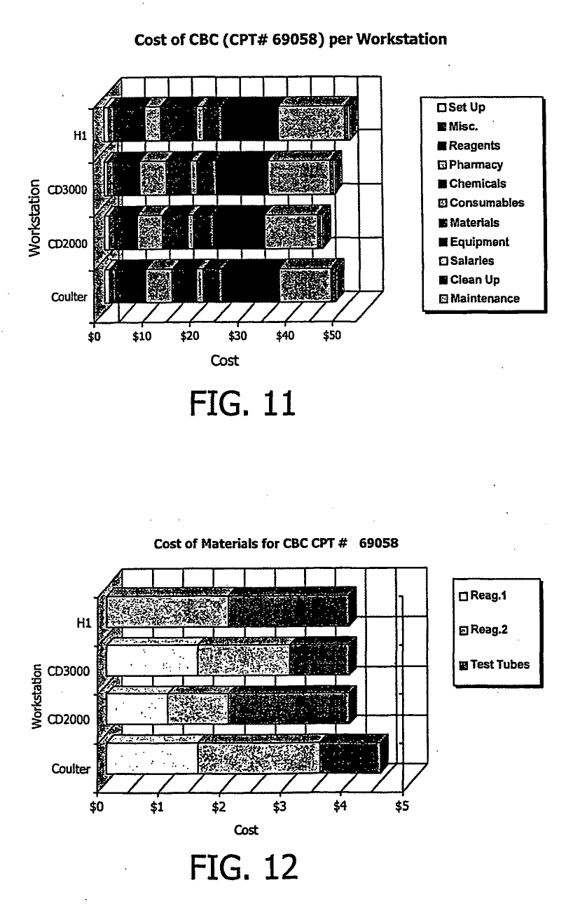

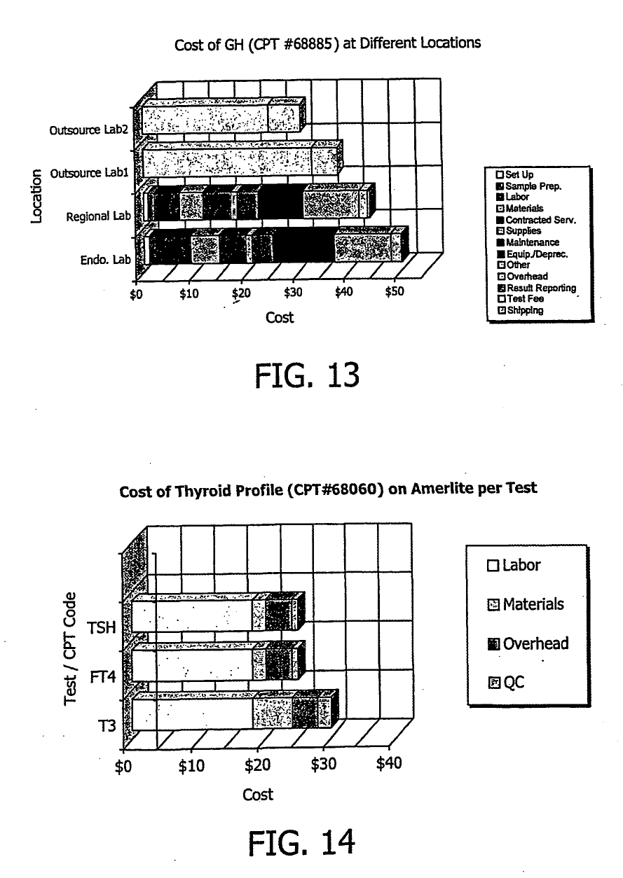

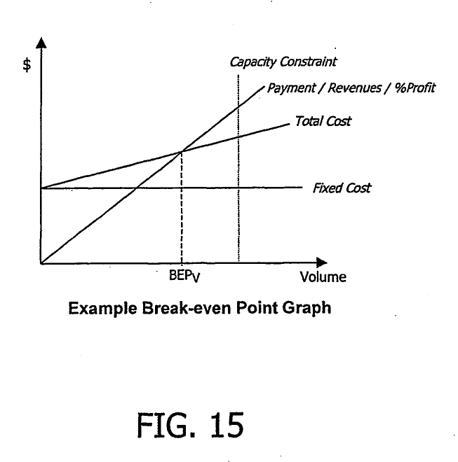

Reference is now made to FIGS. 10 to 14, which show various examples of the graphic view of the cost analysis results, provided by cost analysis module 70, in response to different user queries. A user can request to display actual vs. baseline costs for any specific procedure during any period (FIG. 10); to display the total cost (FIG. 11), or the cost of a particular component (FIG. 12), of any procedure on different workstations; to compare the cost of a procedure carried out in his institution to the costs at other locations (FIG. 13); to see costs profile on a particular workstation (FIG. 14) etc. Cost analysis module 70 also provides break-down analysis tools and displays break-down graphs, an example of which is shown in FIG. 15. In addition to a graphic display this module can also generate numeric views, OLAP views and written reports, according to user specifications. It is particularly important to note that the present invention allows cost analysis starting at the level of individual product, thus actually allowing any product within a healthcare organization to become an independent profit center. Cost analysis by the present invention may be obtained on-line and in real time. It also provides the baseline cost analysis as well as benchmarking as is shown below. Cost analysis is performed also at the level of a workstation and responsibility center. This allows each to become a profit center.

Simulation Module

Simulation module 80 provides tools for creating “What-if” scenarios and for budget forecasting. This module provides the user with answers to questions such as: How will a change in the price of a cost item influence the costs pertaining to a particular test/instrument/department (For example, in case a supplier intends to raise all prices by 5%)? How will the costs/utilization in a particular department be influenced by an increase in the volume of tests performed (for example, if the lab gets a new contract)? How will the purchase of a new instrument influence the current/forecasted costs? How will the addition/deletion of a new test/profile/procedure influence our costs? How will the substitution of one cost item with another, influence the overall cost (for example, if we purchase reagents from a cheaper source)? A user can create a scenario for a single cost object, per group of cost objects, for a patient care unit, and for any period of time. A user can easily initiate different simulation schemes by entering a “new” price for any item a “new” quantity, “new” volume or a “new” cost. The system allows a user to save the simulation results for later reference. In accordance with one embodiment of the present invention, the present system can further include a recommender/analyzer module which recommends different equipment, reagents, supplies or personnel to encourage greater profitability. While the cost analysis functions assist the user in drilling down to different views of cost, the recommender provides direction for the user where or what to drill down. This module enables the user to view all the products where recommendations exist, and view the specific suggestion that can be made to help lower cost. Simulation is achieved by entering various changes at each level (e.g. cost item, product, workstation and responsibility center) and requesting simulation module 80 to show how the entered data has affected data already entered into the data warehouse 101. Simulation module temporarily alters the items changed on data warehouse 101 and presents the display requested (as shown in FIGS. 10-15) showing the simulated result. User 200 may decide to keep changes made and enter them permanently to data warehouse 101 thus changing the user's baseline data or setup information as previously received. For example, a user 200 may decide to simulate a change in the Lab Director hours worked on a particular product. Such change is likely to reduce the product cost and increase the competitive positioning of user 200 in respect of the product for which a lower price can now be charged. Similarly, user 200 may hold several simulations to arrive at a result according to which less reagent (cost item) is used in a particular test (product), this lowering fixed costs and lowering the overall cost of the test.

Benchmarking Module

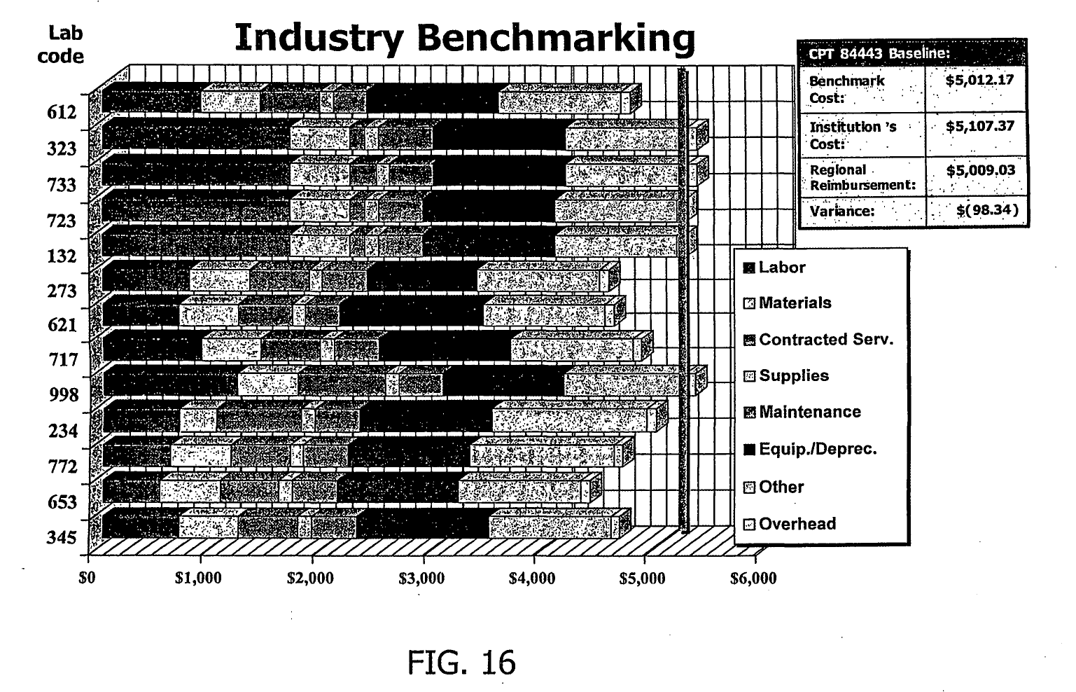

One of the important advantages of the ASP approach of the present invention is the ability to establish data warehouse 101 which enables a continuous and comparative measurement of any healthcare procedure or service (i.e., product) provided by a certain unit against similar products provided by other intra- or inter-institutional units. Data warehouse 101 further allows large scale statistical analyses according to different parameters and establishing standards for healthcare industry costing. The present system provides such benchmarking capabilities by means of benchmarking module 90. An example of an analysis provided by module 90 is shown in FIG. 16. In this example the costs of a CPT #84443 are compared between different labs and against the benchmark cost. The system allows user to select the size, volume, type and location of the institution to compare with. As seen each column may be divided into the various categories (such as LABOR, MATERIALS and the like). A line showing the reimbursement (price) of the product is shown near the $5,000 line and a comparison table shows the variance between the reimbursement and the user's cost of the product.

In combination with the above-described services provided by system 100, the present invention preferably further includes a healthcare portal for providing healthcare related information and services, such as news, forums, training, consulting, purchasing, supply and e-commerce opportunities as well as links to other healthcare organizations-related sites over the data network. In particular, the present invention is suitable for initiating e-commerce directly from the point-of-need. Thus, when a user “drills-down” to specific items while using any of the cost-analysis or cost-control services offered by the application modules of the present invention, the user can be connected directly to vendors selling these specific items. In accordance with this embodiment, system 100 comprises a further database which contains lists of providers categorized according to the items or services they supply and according to their geographic location. This approach of initiating e-commerce directly from the point-of-need fits into other aspects of the present invention which in general, gives lower level employees more decision-making authority with regard to purchasing by providing accurate and real cost analysis and simulation tools. Initiating e-commerce directly from a point-of-need may be achieved by linking various web sites of vendors to the specific server application 11 and allowing user 200 to point and click onto a particular link of relevance when in need of a particular resource such as reagents, personnel, disposables, laundry service, shipping services and the like. A list of such services can be readily appreciated when looking at Table 1 examples of main cost category items as shown above.

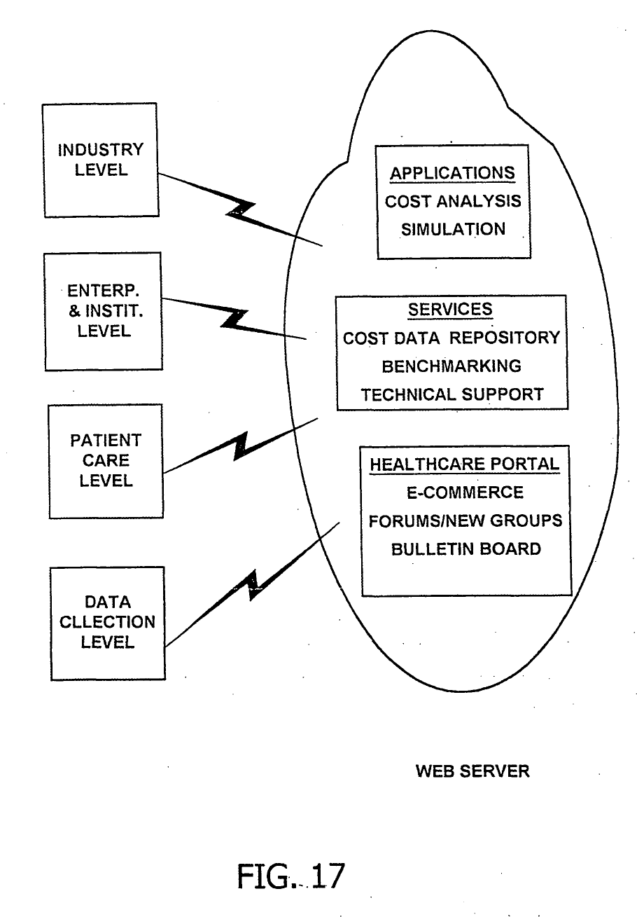

FIG. 17 represents an overview of the entities and activities associated with the web-server in accordance with the present invention and of the services it provides. The present invention can be employed by all levels of health care organizations (e.g. data collection level, patient care level, enterprise and institutional level and industry level).

It will be appreciated by persons skilled in the art that the present invention is not limited to what has been particularly shown and described hereinabove. Rather the scope of the present invention is defined only by the claims which follow.

1. In a data communication network having at least one user, a computerized server system for providing activity-based cost-analysis and cost-control services for the healthcare industry, said system having a CPU and storage device, said system comprising:
a data exchange module for allowing the user to upload activity data into said computerized system;
an analytical engine for processing said activity data, in accordance with said organizational structure and said product tree into product cost data.

2. The system of claim 1 further comprising a setup module for allowing a user to define an organizational structure, product cost trees and user administration details.

3. The system of claim 1 further comprising a repository database, the repository database includes healthcare related data including an analyzers list, a healthcare product list and pre-defined product cost trees corresponding to each of the products in said list, wherein the setup means comprising accessibility to said repository database.

4. The system of claim 1 further comprising a setup database coupled to said setup module for storing users organizational structure and customized user product trees.

5. The system of claim 1 further comprising an activity database coupled to said data exchange module for storing users activity data.

6. The system of claim 1 further comprising a data warehouse for storing said product cost data.

7. The system of claim 6 wherein the data warehouse is a multidimensional database.

8. The system of claim 1 wherein a product cost tree includes, in an hierarchical structure, the cost items associated with the production of the product and wherein each of the cost items is associated with a baseline quantity or with a formula for calculating the baseline quantity.

9. The system of claim 1 wherein said organizational structure is defined in terms responsibility centers, workstations and products wherein each product is linked to a workstation and each workstation is linked to a responsibility center.

10. The system of claim 1 wherein said activity data includes consumption data, performance data, item price data and optionally reimbursement data.

11. The system of claim 1 wherein the data exchange module includes means for allowing manual uploading of the activity data.

12. The system of claim 1 wherein the data exchange module includes means for allowing the user to define information source files residing in the user computer system, the information source files include user activity data.

13. The system of claim 12 wherein the data exchange module integrates to existing Information Systems residing in the user system for allowing automatic uploading of the user activity data into the server computerized system.

14. The system of claim 1 wherein said analytical engine includes algorithms for calculating the actual quantities of cost items comprising a product tree in accordance with the user consumption and performance data whereby actual quantities are calculated by multiplying the baseline cost item quantity by the bias of the cost item consumption, wherein the bias is the ratio between the actual and expected consumption.

15. The system of claim 14 wherein the actual quantities are calculated per product as follows:
$${aiqi}_{i} = \frac{a c}{{\sum }_{l} {avt}_{i} * {biq}_{i}} * {biq}_{i}$$

16. The system of claim 1 further comprising a cost analysis module, the cost analysis module providing information generated by the analytical engine and stored in the data warehouse thereby providing the user with cost analysis information.

17. The system of claim 16 wherein the cost analysis information is generated and provided to the user in real time.

18. The system of claim 1 further comprising a simulation module, the simulation module providing information generated by the analytical engine and stored in the data warehouse thereby providing the user with simulations and budget forecasting.

19. The system of claim 1 further comprising a benchmarking module, the benchmarking module integrates data stored in the data warehouse and repository to display various unit comparisons.

20. The system of claim 1 further comprising a module for initiating e-commerce at the point of need.

21. The system of claim 1 wherein the data communications network is the Internet.

22. The system of claim 1 wherein the data communications network is a local area network.

23. In a data communication network comprising a plurality of healthcare providers computerized systems, a method implemented in a server computerized platform accessible to said computerized systems by a client system, for providing activity-based cost-analysis and cost-control services for said healthcare providers, said method comprising the following steps:
i) receiving and storing activity data in a database;
ii) upon receiving a request for cost analysis task from a user, processing the activity data in accordance with an organizational structure related data, to obtain cost analysis results in accordance with the cost analysis task;

24. The method of claim 23 further comprises the step of providing a user with setup module for collecting and defining an organizational structure, product trees and administration details.

25. The method of claim 23 further comprises the step of receiving the organizational structure related data of said user.

26. The method of claim 23 further comprises the step of storing the organizational structure related data of said user in a database.

27. The method of claim 26 wherein the database is a users setup database.

28. The method of claim 23 further comprises the step of providing a user with a module to upload activity data at predetermined times into the server computerized platform.

29. The method of claim 28 wherein the step of providing the user with a module to upload activity data further comprises the steps of:
preparing the files to be uploaded by creating uploaded files description and configuring the upload process;
uploading the files to the server.

30. The method of claim 28 wherein the activity data is raw.

31. The method of claim 23 wherein the database for storing activity data is a users activity database.

32. The method of claim 23 further comprises the step of providing a user with a module to request various cost analysis, simulation, budgeting and benchmarking tasks.

33. The method of claim 23 wherein the processing of activity data is performed by a cost analysis module.

34. The method of claim 32 wherein the cost analysis module determines actual quantities by multiplying the baseline cost item quantity by the bias of the cost item consumption, wherein the bias is the ratio between the actual and expected consumption.

35. The method of claim 34 wherein the actual quantities are calculated per product as follows:
$${aiqi}_{i} = \frac{a c}{{\sum }_{l} {avt}_{i} * {biq}_{i}} * {biq}_{i}$$

36. The method of claim 23 further comprises the step of sending results to a user over a data communication network.

37. In a data communication network having at least one user, a computerized organizational structure for storing activity-based cost-analysis and cost-control services for the healthcare industry, said organizational structure having a storage device and connected to at least one CPU, said organizational structure comprising:
At least one responsibility center;
For each responsibility center at least one workstation; and
For each workstation at least one product cost tree, the product cost tree is associated with at least one cost item holding data relative to the product cost tree.

38. The apparatus of claim 37 wherein the product cost tree is a procedure defined by the quantity and allocation formula for calculating the cost of the procedure in relation to the cost item.

39. The apparatus of claim 38 wherein the product cost tree is a service defined by the quantity and allocation formula for calculating the cost of the service in relation to the cost item.

40. The apparatus of claim 37 wherein the product cost tree is further comprises at least one main cost category and at least one sub level category.

41. The apparatus of claim 40 wherein the main cost categories are predetermined and fixed.

42. The apparatus of claim 40 wherein the sub level category is flexible.

43. The apparatus of claim 37 wherein a cost item is a direct cost relating to the production of a product.

44. The apparatus of claim 37 wherein a cost item is an indirect costs relating to the overall expense of operating the at least one responsibility center.

45. The apparatus of claim 37 wherein a cost item is a fixed cost that does not change as the volume of the item changes.

46. The apparatus of claim 37 wherein a cost item is a variable cost that changes as the volume of the item changes.

47. The apparatus of claim 37 wherein a cost item further includes information about quantity relating to a baseline quantity defined for the item cost, and allocation basis formula for allocating costs associated with the cost item.
